(19) United States
(12) Patent Application Publication
(10) Pub. No.: US 2004/0124564 A1
(43) Pub. Date: Jul. 1, 2004

(54) Process for preparing a chemically modified fibrin-fibrillar protein (FFP) composite sheet

(76) Inventors: Sheik Eusuff Noorjahan, Tamil Nadu (IN); Mandyam Devasikamani Ranganayaki, Tamil Nadu (IN); Ganga Radhakrishnan, Tamil Nadu (IN); Bhabendra Nath Das, Tamil Nadu (IN); Ummadisetty Venkateswarlu, Tamil Nadu (IN); Chellan Rose, Tamil Nadu (IN); Thotapalli Parvathaleswara Sastry, Tamil Nadu (IN)

Correspondence Address: NIXON & VANDERHYE, PC, 1100 N GLEBE ROAD, 8TH FLOOR, ARLINGTON, VA, 22201-4714, US

(21) Appl. No.: 10/330,477

(22) Filed: Dec. 30, 2002

(51) Int. Cl. B29C 39/02; B29C 71/04

(52) U.S. Cl. 264/488; 264/299

(57) ABSTRACT

The present invention relates to a process for the preparation of a novel chemically modified fibrin-fibrillar protein (FFP) composite sheet for medical application and the FFP composite prepared thereby. The FFP sheet finds potential use as a dressing aid in the treatment of various external wounds of different nature, which include cut wounds, burn wounds and even ulcers in animals and human beings.

### FIELD OF THE INVENTION

The present invention relates to a process for preparing a novel chemically modified fibrin-fibrillar protein composite (FFP) sheet for medical application and to fibrin-fibrillar composite (FFP) prepared thereby. The FFP sheet is useful as a dressing aid in the treatment of various external wounds of different nature, which include external injury, cut wounds, burn wounds and even ulcers in animals and human beings.

### BACKGROUND OF THE INVENTION

Efficacy of wound healing of the sheet increases manifold when anti-inflammatory drugs, bactericides and even antibiotics such as terramycin, gentamycin and cephalaxin are incorporated therein. Bleeding from any wound in an animal body stops automatically due to the natural process of blood clotting caused by the conversion of fibrinogen present in blood into fibrous nets like fibrin due to action of thrombin and fibrin stabilizing factor. (Lorand, L. and Ong, H. H, Biochemistry 5, 1747, 1966 a; Lorand, L. and Ong, H. H, Biochem. Biophys. Res. Comm.23, 188, 1966b; Lorand, L. Ong, H. H, Lipinski, B, Rule N. G., Downey, J and Jacobsen, A, Biochem, Biophys Res. Comm., 25, 629, 1966). Thus the fibrin clot acts as a good haemostatic agent. Although this net like structure arrests the blood cells, which cannot come out, serum still oozes out along with electrolyte and thereby causes microbial infection. It is therefore, necessary to dress the wound externally to accelerate the healing process.

Synthetic materials normally used for dressing the external wounds include band-aid, sys pur derm, nylon velour, polyester urethane and biomaterial like biobrane. These materials can only prevent airborne infection by covering the wound. Compatibility of the synthetic material with the animal body is obviously a matter of great concern for wound dressing. Moreover, since these materials require frequent changes, a lot of dressing materials are necessary. Keeping in mind the ever-growing concern for hygienic products, global attention has recently been shifting towards less-hazardous natural products.

Miller (Biochemistry vol. 10, 1971, pp1652) homogenized collagenous tissues and solubilised them with limited pepsin digestion and the solubilised collagen was precipitated from clarified supernate by addition of 1M sodium chloride. The precipitate was dissolved in cold 1M sodium chloride, 50 mM Tris HCl at pH 7.5, titrated to pH 8.6 to inactivate residual pepsin and reprecipitated by exhaustive dialysis against 0.01M disodiux hydrogen phosphate. The recovered precipitate w dissolved and dialysed against 0.5M acetic acid and lyophilized. Stal et al (Biomaterials, vol. 6, 1985, pp193) prepared fibrillar collagen from bovine hide utilizing EDTA. The 2% (w/v) dispersion of collagen was prepared in 1% (v/v) aqueous acetic acid and stored at +4° C.

Poultry chicken feathers were hydrolysed by Sehgal et al (Leather Sci, vol. 33, 1986, pp 333) under controlled alkaline conditions. Undigested material was rejected. Solubilized material was neutralized to pH 6.5-7, filtered and dried. The dried keratin hydrolysate (KH) is water soluble.

Raw blood is defibrinated by vigorous churning for the purpose of isolating various biochemicals like haemoglobin. The crude fibrin, separated from raw blood during the process of defibrination, does not produce good film. Even after drying, this fibrin cannot be used for wound dressing due to its brittle nature. This crude fibrin is either rejected usually as waste or used sometimes as plant-fertilizer.

Babu and Sastry, et al (J. Appl. Polym. Sci. Vol. 65, 1997, pp. 555) prepared hydrogels based on gelatin poly (hydroxyethyl methacrylate) and poly (butyl acrylate) graft copolymer impregnated with fibrin. In this process, fibrin as a powder was added in the final stages of the reaction and apparently, it is not grafted. As the grafted gelatin is the main component and fibrin is only an impregnant material, separation of two phases is seen in the product.

Sastry et.al (J.Appl.Polym.Sci.Vol.68, 1998, pp.1109) prepared chemically modified fibrin-gelatin composites using ferric chloride and hydrogen peroxide redox system. The drawback of this system is that the thickness of the final product is more and handling was difficult while applying onto the wound.

Laki (Fibrinogen, Marcel Dekker, Inc, New York, 1968) indicate that fibrin can be isolated from fibrinogen and made in the form of sponge, film, powder, fibrin glue, etc. Fibrinogen is isolated from blood using centrifugation in combination with cryoprecipitation or precipitating agents like ethanol, ammonium sulfate or polyethyleneglycol. Concentrated solution of isolated fibrinogen is diluted and mixed with thrombin in aqueous medium to form fibrin suspension. This mixture is dried in the form of a sheet to produce natural fibrin sheet, which is used for dressing of wound.

The main drawback of this system is that fibrin being a protein, is susceptible to decay by proteolytic attack. Thus shelf life of this natural fibrin film is obviously very low, because crude protein is used as such in this process. For the same reason, it requires frequent changes of dressing and lingers the healing process, when used for wound dressing. Another drawback of this natural fibrin film is that thrombin is not readily available and it adds to the cost of preparation of the film. Yet another limitation of this natural film is that coupling of other drug is not possible for the betterment of the functionality of the product.

The process of preparation of (a) novel fibrin sheet is described in Indian Patent No. 185743, (b) novel fibrin powder in Indian Patent Application No. 2597/DEL/97, (c) novel fibrin sponge in Indian Patent Application No. 2787/DEL/97. In these disclosures, fibrin was used as such without incorporating any film forming protein.

### OBJECTS OF THE INVENTION

The main object of the invention is to provide a process for preparing fibrin-fibrillar protein composite sheet for medical application which overcomes the above drawbacks.

Another object of the invention is to utilize the fibrin-fibrillar protein sheet for graft copolymerization.

Yet another object of the invention is to prepare a product which is capable of incorporating drugs like bactericides and antibiotics such as terramicin, gentamicin, cephalexin for effecting better efficacy of the treatment.

Still another object of the invention is to prepare novel fibrin-gelatin composite sheet with better longevity on wound, so that the number of dressings can be reduced.

### SUMMARY OF THE INVENTION

In the present invention, fibrin from raw blood is used as an ingredient for preparation of wound dressing material. A fibrillar protein is added to the fibrin to enhance the tensile strength of the material, thereby enabling easy handling by surgeons/physicians.

Accordingly the present invention provides a process for preparing a novel fibrin-fibrillar protein composite sheet for medical application which comprises

i. treating crude fibrin in aqueous medium with a metallic salt of an organic acid to purify the crude fibrin,

ii. bleaching the purified fibrin formed in step (i) with a bleaching agent,

iii. masticating the bleached fibrin formed in step (ii) to form a paste,

iv. preparing 2-10% w/v fibrillar protein solution in aqueous medium,

v. mixing the paste formed in step (iii) with fibrillar protein solution, plasticizer and crosslinker to obtain composite,

vi. converting the composite into sheet,

vii. drying the resulting composite sheet formed in step (vi),

viii graft copolymerising the fibrin-fibrillar protein composite formed in step (vii) with an acrylic monomer in the presence of a redox initiator to obtain a crude graft copolymer,

ix. treating the crude graft copolymer with an organic solvent to remove the homopolymer,

x. sterilising the resultant copolymer by exposing it to gamma irradiation.

In one embodiment of the invention, the bleaching in step (ii) is carried out at a pH in the range of 3 to 11.

In one embodiment of the invention, the bleaching step is carried out at a pH in the range of 7 to 11 using sodium hydroxide or potassium hydroxide solution.

In another embodiment of the invention, the pH of 3 for the bleaching step is obtained by using HCl solution.

In another embodiment of the invention, the 2-10% w/v fibrillar protein solution in aqueous medium is prepared at a temperature in the range of 20 to 50° C.

In yet another embodiment of the invention, the mixing in step (v) of the paste formed in step (iii) with fibrillar protein solution, plasticizer and crosslinker is carried out at a temperature in the range of 40-55° C. to obtain composite.

In another embodiment of the invention, the graft copolymerisation in step (viii) is carried out at a temperature in the range of 40 to 70° C. and over a period of 2 to 4 hours.

In another embodiment of the invention, the graft copolymer obtained in step (viii) is coupling with a drug.

In another embodiment of the invention, the amount of metallic salt of organic acid used to purify the crude fibrin is in the range of 2-5% by weight of the fibrin paste weight.

In another embodiment of the invention, the amount of fibrillar protein solution added in step (v) is in the range of 2-6% w/v to prepare the composite.

In yet another embodiment of the invention, the crosslinking agent is added in an amount of 0.2 to 2% w/v by weight on the fibrin paste weight.

In another embodiment of the invention, the amount of plasticizer added is in the range of 1 to 4% w/v on the weight of purified fibrin paste weight.

In yet another embodiment of the invention, the amount of acrylic monomer added is in the range of 300 to 500% w/v on dry film composite weight.

In another embodiment of the invention, the amount of redox initiator added is in the range of 20 to 50% w/w on the weight of dry film composite.

In yet another embodiment of the invention, the thickness of the modified fibrin-fibrillar protein composite is in the range of 1-4 mm.

In another embodiment of the invention, the resulting composite sheet is sterilized by exposure to gamma irradiation in the range of 1-3 M rads and then stored in 90-95% solution of an aqueous organic solvent.

In another embodiment of the invention, the metallic salt of the organic acid used in step (i) is selected from sodium acetate and potassium acetate.

In another embodiment of the invention, the plasticizer is selected from the group consisting of glycerol, ethyleneglycol, triethyleneglycol and polyethyleneglycol.

In another embodiment of the invention, the drug coupled to the graft copolymer comprises drugs containing —NH₂, —OH and —COOH groups

In another embodiment of the invention, the bleaching agent is selected from hydrogen peroxide and sodium peroxide.

In another embodiment of the invention, the fibrillar protein is selected from the group consisting of gelatin, collagen and keratin hydrolysate.

In another embodiment of the invention, the initiator is selected from the group consisting of sodium metabisulfite, ammonium persulfate, potassium persulfate and any mixture thereof.

In another embodiment of the invention, the acrylic monomer is selected from the group consisting of hydroxypropyl methacrylate, hydroxy ethylmethyacrylate and methylmethacrylate

In another embodiment of the invention, the crosslinking agent used is selected from the group consisting of glutaraldehyde, basic chromium sulfate and genipin.

In another embodiment of the invention, the drug containing —NH₂ group is selected from the group consisting of kanamycin, gentamycin, tobramycin and neomycin.

In another embodiment of the invention, the drug containing —COOH group is selected from the group consisting of cephalexin, nalixic acid and oxolonic acid.

In another embodiment of the invention, the drug containing —OH groups is selected from rifamycin and tetracycline.

### DETAILED DESCRIPTION OF THE INVENTION

Crude fibrin obtained after defibrinating raw blood is used as starting material for the present invention. It is washed conventionally in 3-5 changes of plain water and 2-5% w/w of a metallic salt of an organic acid and then dissolved in 20-250 times of volume of water to remove blood clots. Washed fibrin is then suspended in 80-150% w/v of water and is bleached with 10-30% v/v, of a conventional bleaching agent at a pH in the range of 7.5-10, adjusted by a conventional alkali, over a period of 10-15 hours. The colour of the fibrin, at this stage turns white. The bleached fibrin is washed in 200-300% w/v of plain water for 10-20 min. and then ground to form a paste. To the ground fibrin paste, 2-6% w/v of a fibrillar protein solution (2-10%), 0.2-2% w/v of crosslinking agents, 1-4% w/v of a plasticizer are mixed together and then dried at 40-70° C. to get dry fibrin-gelatin composite film of thickness in the range of 1-3 mm.

The dried film is soaked in 2000-4000 times w/v of water over a period of 2-5 hrs. The well soaked film is polymerized with 300-500% by weight of acrylic monomers on dry film weight in the presence of 20-50% w/w, of redox initiator on the dry fibrin-gelatin film at a temperature in the range of 40-70° C. over a period of 30-180 mins.

8-15 parts by weight of a drug containing —NH₂, —OH, —COOH groups on fibrin weight is optionally treated with the reaction mixture with constant stirring for preparing drug-coupled (fibrin-fibrillar protein)-polyacrylate graft copolymer. The reaction is continued for a further period of 20-40 mins.

Completion of polymerization reaction is ascertained by titration. The resulting graft copolymer sheet is treated with 3-5 times w/v of an organic solvent to extract the homopolymers present in the sheet over a period of 30-40 hrs.

The resulting sheet is sterilized by exposing the same to gamma irradiation in the range of 1-3 M rads and is stored in 90-95% solution of an aqueous organic solvent.

Thus this process of invention provides a simple new method of utilizing crude fibrin economically for making fibrin-fibrillar protein composite in the form of a sheet of better efficacy, stability and shelf-life.

The non obviousness of this patent lies in the judicial mixture of fibrin and selected fibrillar proteins and crosslinking agent. The non obviousness also lies in the amount of a particular monomers that give the fibrin-fibrillar protein composite, the hydrogel property. Hydrogels absorb wound fluids effectively and keep the wound dry and clean thereby hasten the wound healing.

If the wound dressing material is coupled with antibiotics, it can be used on the infected wounds. Otherwise the bacteria may also degrade the wound dressing material. Antibiotic wound dressing material prevents airborne infection and thereby protects the wound surface from the pathogens. There are certain wound dressing materials, i.e., collagen sheet, porcine graft, biobrane, etc. These materials cannot be used on the infected wounds.

The FFP sheet of the invention such as a fibrin-gelatin sheet, applied on a wound, heals it in three different ways:

a. Acts as a hydrogel; by not only imbibing the exudates but also preventing the loss of electrolytes from the wound

b. Acts as a haemostatic agent, by preventing blood loss

c. Acts as a barrier, by preventing any air borne infection

The following examples are given by way of illustration and should not be construed to limit the scope of the present invention.

### EXAMPLE-I

500 gms of crude fibrin containing blood clots was collected from a slaughter house for the present experiment. It was washed thoroughly under running water and then treated with 25 gms of sodium acetate, dissolved in 1 lit of water to remove the blood clots/blood stains from the fibrin. Blood clot free fibrin was then put in 750 ml. of water in a plastic tub. pH of the bath was adjusted to 8.5 by adding a few drops of 0.1N sodium hydroxide solution. 25 ml. of hydrogen peroxide was then added with constant stirring for 10 hrs, after which colour of the fibrin turned to white. The bleached white fibrin was removed from the bleaching bath, washed thoroughly with cold running water and ground with the help of mixer to form a paste, 100 gms of the ground paste was mixed with 2 ml of 10% gelatin solution, 1 ml of Triethylene glycol and 0.2 ml of glutaraldehyde. The mixed paste was cast as a film and dried at 40° C. in a hot air oven for 5 hrs. to get dry fibrin gelatin film of thickness 2 mm. 1 gm. of the above fibrin-gelatin film was soaked in 20 ml water for 3 hrs. in a 100 ml conical flask fitted with a two necked adapter. 0.1 gm of sodium metabisulphite and an equal amount of potassium persulphate were added to the above mixture with constant stirring and the reaction mixture was heated to a temperature at 55° C. Then 3 ml. of hydroxyethyl methacrylate was added drop by drop to the solution with stirring, which was continued for a further period of 45 mins. Temperature was maintained at 55° C. throughout the reaction. Later, 40 g gentamycin was added and the reaction was continued for a further period of 20 min. At the end of the reaction, butylamine titration confirmed the absence of the free hydroxyethyl methacrylate and hence completion of the polymerization reaction. The resulting (fibrin-gelatin)—polyhydroxyethyl methacrylate graft copolymer was taken out from the flask and kept in 100 ml of plain water in a beaker. After a period of 1 hr, water was decanted and the wet copolymer was treated with 100 ml of acetone for 30 hrs with continuous shaking. The resulting copolymer which is in the sheet form is exposed to gamma irradiation at 1 M rads. The (fibrin-gelatin)—polyhydroxyethyl methacrylate graft copolymer sheet was finally stored in polythene covers.

### EXAMPLE-2

200 gms of crude fibrin containing blood clots was collected from the slaughterhouse for the present experiment. It was washed thoroughly under running water and then treated with 20 gms of potassium acetate, dissolved in 300 ml of water to remove the blood clots/blood stains from the fibrin. Blood clot free fibrin was then put in 300 ml of water in a plastic tub. pH of the bath was adjusted to 8 by adding a few drops of 0.1N potassium hydroxide solution, 5 gms of sodium peroxide dissolved in 20 ml of water was then added with constant stirring for 8 hrs after which colour of the fibrin turned to white. The bleached white fibrin was removed from the bleaching bath, washed thoroughly with cold running water and ground with the help of mixer to form a paste. 100 gms of the ground paste is mixed with 4 ml of 2% collagen solution, 3 ml of polyethyleneglycol and 0.1 g of basic chromium sulphate. The mixed paste was cast as a film and dried at 55° C. in a hot air oven for 7 hrs to get a dry fibrin-gelatin film of thickness 1 mm. 1 gm of the above fibrin-collagen film is soaked in 30 ml water for 3 hrs in a 100 ml conical flask fitted with a two necked adaptor. 0.15 gms of sodium metabisulphite and an equal amount of ammonium persulphate were added to the above mixture with constant stirring and the reaction mixture was heated to a temperature of 60° C. Then 4.0 ml of hydroxypropyl methacrylate was added drop by drop to the solution with stirring, which was continued for a further period of 45 mins. Temperature was maintained at 60° C. throughout the reaction. Later, 20 g of cephalexin was added and the reaction was continued for a further period of 30 min. At the end of the reaction, butylamine titration confirmed the absence of free hydroxy propylmethacrylate and hence completion of the polymerization reaction. The resulting (fibrin-collagen)-polyhydroxy propylmethacrylate graft copolymer sheet was taken out from the flask and kept in 75 ml of plain water in a beaker. After a period of 1 hr, water was decanted and the wet sheet was treated with 75 ml of ethanol for 35 hrs with continuous shaking. The resulting copolymer which is in sheet form is exposed to gamma irradiation at 3M rads. The (fibrin-collagen)-polyhydroxypropyl methacrylate graft copolymer sheet was finally stored in polythene covers.

### EXAMPLE-3

1000 gms of crude fibrin containing blood clots was collected from the slaughter house for the present experiment. It was washed thoroughly under running water and then treated with 50 gms of sodium acetate, dissolved in 2 lit. of water to remove the blood clots/blood stains from the fibrin. Blood clot free fibrin was then put in 1.5 lit of water in a plastic tub. pH of the bath was adjusted to 3 by adding a few drops of 0.1N hydrochloric acid, 50 ml of hydrogen peroxide was then added with constant stirring for 7 hrs. after which colour of the fibrin turned to white. The bleached white fibrin was removed from the bleaching bath, washed thoroughly with cold running water and ground with the help of mixer to form a paste. 100 gms of the ground paste is mixed with 6 ml of 5% keratin hydrolysate (KH) solution, 4 ml of ethyleneglycol and 1 g of genipin. The mixed paste was cast as a film and dried at 55° C. in a hot air oven for 8 hrs to get dry fibrin-gelatin film of thickness 1.5 mm. 1 gm of the above fibrin-KH film is soaked in 40 ml water for 4 hrs in a 100 ml conical flask fitted with a two necked adaptor. 0.25 gm of sodium metabisulphite and an equal amount of ammonium persulphate were added to the above mixture with constant stirring and the reaction mixture was heated to a temperature of 45° C. Then 5 ml of methyl methacrylate was added drop by drop to the solution with stirring, which was continued for a further period of 1 hr. Temperature was maintained at 45° C. throughout the reaction. Later, 150 gm of tetracycline was added and the reaction was continued for a period of 40 min. At the end of the reaction, butylamine titration confirmed the absence of the free methyl methacrylate and hence completion of the polymerization reaction. The resulting (fibrin-KH)-poly methyl methacrylate graft copolymer was taken out from the flask and kept in 200 ml of plain water in a beaker. After a period of 2 hrs, water was decanted and the wet copolymer was treated with 200 ml of ethanol for 36 hrs with continuous shaking. The resulting copolymer which is in sheet form is exposed to gamma irradiation at 3M rads. The (fibrin-KH)-polymethyl methacrylate graft sheet was finally stored in polythene covers.

We claim

1. A process for preparing a fibrin-fibrillar protein composite sheet which comprises
i. purifying the crude fibrin by treatment thereof in aqueous medium with a metallic salt of an organic acid,
ii. bleaching the purified fibrin formed in step (i) with a bleaching agent,
iii. masticating bleached fibrin formed in step (ii) to form a paste,
iv. preparing 2-10% w/v fibrillar protein solution in aqueous medium,
v. mixing the paste formed in step (iii) with fibrillar protein solution, plasticizer and crosslinker to obtain composite,
vi. converting the composite into sheet,
vii. drying the resulting composite sheet formed in step (vi),
viii. graft copolymerising fibrin-fibrillar protein composite formed in step (vii) with an acrylic monomer in presence of a redox initiator to obtain crude graft copolymer,
ix. treating crude graft copolymer with an organic solvent to remove homopolymer,
x. sterilising the resultant copolymer composite sheet by exposing it to gamma irradiation.

2. A process as claimed in claim 1 wherein the bleaching is carried out at a pH in the range of 3 to 11.

3. A process as claimed in claim 2 wherein the bleaching step is carried out at a pH in the range of 7 to 11 using sodium hydroxide or potassium hydroxide solution.

4. A process as claimed in claim 2 wherein the pH of 3 for the bleaching step is obtained by using HCl solution.

5. A process as claimed in claim 1 wherein the 2-10% w/v fibrillar protein solution in aqueous medium is prepared at a temperature in the range of 20 to 50° C.

6. A process as claimed in claim 1 wherein paste formed in step (iii) is mixed with fibrillar protein solution, plasticizer and crosslinker at a temperature in the range of 40-55° C.

7. A process as claimed in claim 1 wherein the graft copolymerisation is carried out at a temperature in the range of 40 to 70° C. and over a period of 2 to 4 hours.

8. A process as claimed in claim 1 wherein the graft copolymer obtained in step (viii) is coupling with a drug.

9. A process as claimed in claim 1 wherein the amount of metallic salt of organic acid used to purify the crude fibrin is in the range of 2-5% by weight of the fibrin paste weight.

10. A process as claimed in claim 1 wherein the amount of fibrillar protein solution added in step (v) is in the range of 2-6% w/v to prepare the composite.

11. A process as claimed in claim 1 wherein the crosslinking agent is added in an amount of 0.2 to 2% w/v by weight on the fibrin paste weight.

12. A process as claimed in claim 1 wherein the amount of plasticizer added is in the range of 1 to 4% w/v on the weight of purified fibrin paste weight.

13. A process as claimed in claim 1 wherein the amount of acrylic monomer added is in the range of 300 to 500% w/v on dry film composite weight.

14. A process as claimed in claim 1 wherein the amount of redox initiator added is in the range of 20 to 50% w/w on the weight of dry film composite.

15. A process as claimed in claim 1 wherein the thickness of the modified fibrin-fibrillar protein sheet is in the range of 1-4 mm.

16. A process as claimed in claim 1 wherein the metallic salt of the organic acid used in step (i) is selected from sodium acetate and potassium acetate.

17. A process as claimed in claim 1 wherein the plasticizer is selected from the group consisting of glycerol, ethyleneglycol, triethyleneglycol and polyethyleneglycol.

18. A process as claimed in claim 1 wherein the drug coupled to the graft copolymer comprises drugs containing —NH₂, —OH and —COOH groups

19. A process as claimed in claim 1 wherein the bleaching agent is selected from hydrogen peroxide and sodium peroxide.

20. A process as claimed in claim 1 wherein the fibrillar protein is selected from the group consisting of gelatin, collagen and keratin hydrolysate.

21. A process as claimed in claim 1 wherein the initiator is selected from group consisting of sodiummetabisulfite, ammoniumpersulfate, potassiumpersulfate and any mixture thereof.

22. A process as claimed in claim 1 wherein the acrylic monomer is selected from hydroxypropylmethacrylate, hydroxyethylmethyacrylate and methylmethacrylate

23. A process as claimed in claim 1 wherein the crosslinking agent used is selected from the group consisting of glutaraldehyde, basic chromium sulfate and genipin.

24. A process as claimed in claim 18 wherein the drug containing —NH₂ group is selected from the group consisting of kanamycin, gentamycin, tobramycin and neomycin.

25. A process as claimed in claim 18 wherein the drug containing —COOH group is selected from the group consisting of cephalexin, nalixic acid and oxolonic acid.

26. A process as claimed in claim 18 wherein the drug containing —OH groups is selected from rifamycin and tetracycline.

27. A process as claimed in claim 1 wherein the resulting copolymer is sterilized by exposure to gamma irradiation in the range of 1-3 Mrads
